(19) United States
(12) Patent Application Publication
(10) Pub. No.: US 2023/0034236 A1
(43) Pub. Date: Feb. 2, 2023

(54) IMAGE PROCESSING APPARATUS, IMAGE FORMING APPARATUS, AND IMAGE PROCESSING METHOD

(71) Applicant: KYOCERA Document Solutions Inc., Osaka-shi (JP)

(72) Inventors: Koji SATO, Osaka-shi (JP); Hiroka ITANI, Osaka-shi (JP); Shiro KANEKO, Osaka-shi (JP); Naomichi HIGASHIYAMA, Osaka-shi (JP)

(21) Appl. No.: 17/814,322

(22) Filed: Jul. 22, 2022

(30) Foreign Application Priority Data
Jul. 29, 2021 (JP) 2021-123802

(51) Int. Cl. G06T 7/00; G06V 10/22; G06V 10/44; G06V 10/98; G06V 10/771

(52) U.S. Cl. CPC G06T 7/0002; G06V 10/225; G06V 10/449; G06V 10/993; G06V 10/771; G06V 2201/07

(57) ABSTRACT

An abnormality detection unit detects an abnormal object in target images repeatedly acquired. An abnormality type selection unit selects, for each of the target images, an abnormality type of the abnormal object from a plurality of specific abnormality types based on values of at least two basic feature amounts. A feature amount monitoring unit monitors the values of the basic feature amounts and a value of an auxiliary feature amount corresponding to the abnormality type currently selected by the abnormality type selection unit. An adjustment processing unit executes an adjustment process corresponding to the auxiliary feature amount being monitored by the feature amount monitoring unit. The abnormality type selection unit changes the abnormality type to be selected, in accordance with the change in the values of the basic feature amounts mentioned above.

### INCORPORATION BY REFERENCE

This application is based upon, and claims the benefit of priority from, corresponding Japanese Patent Application No. 2021-123802 filed in the Japan Patent Office on Jul. 29, 2021, the entire contents of which are incorporated herein by reference.

### BACKGROUND

### Field of the Invention

The present disclosure relates to an image processing apparatus, an image forming apparatus, and an image processing method.

### Description of Related Art

Generally, in an image processing apparatus such as a multifunction device or a printer, an abnormal image (abnormal object) may occur in a print product or a scanned image due to a certain cause in the image processing apparatus. Abnormal images are, for example, unintended streaks and dots, unevenness that spreads over the entire print product or scanned image, and the like.

An image processing apparatus performs a certain treatment with respect to an image quality defect and then, determines whether the image quality is improved. If the image quality is improved, the relationship between a feature amount of the image and the treatment performed on the image is saved as statistical data. The statistical data is used to estimate a treatment corresponding to the feature amount of an image when the image quality is poor.

### SUMMARY

An image processing apparatus according to the present disclosure includes an abnormality detection unit that detects an abnormal object in target images repeatedly acquired, an abnormality type selection unit that selects, for each of the target images, an abnormality type of the abnormal object from a plurality of specific abnormality types based on values of at least two basic feature amounts, a feature amount monitoring unit that monitors the values of the at least two basic feature amounts and a value of an auxiliary feature amount corresponding to the abnormality type currently selected by the abnormality type selection unit, and an adjustment processing unit that executes an adjustment process corresponding to the auxiliary feature amount being monitored by the feature amount monitoring unit. The abnormality type selection unit changes the abnormality type to be selected, in accordance with a change in the values of the at least two basic feature amounts.

The image forming apparatus according to the present disclosure includes the above-mentioned image processing apparatus and an internal apparatus that generates the target images.

An image processing method according to the present disclosure includes detecting an abnormal object in target images repeatedly acquired, selecting, for each of the target images, an abnormality type of the abnormal object from a plurality of specific abnormality types based on values of at least two basic feature amounts, monitoring the values of the at least two basic feature amounts and a value of an auxiliary feature amount corresponding to the abnormality type currently selected in the selecting, and executing an adjustment process corresponding to the auxiliary feature amount being monitored in the monitoring. In the selecting, the abnormality type to be selected is changed in accordance with a change in the values of the at least two basic feature amounts.

The above or other purposes, features, and advantages of the present disclosure will be further made clear by the following detailed description, together with the accompanying drawings.

### BRIEF DESCRIPTION OF THE DRAWINGS

FIG. 1 is a block diagram illustrating a configuration of an image processing apparatus according to an embodiment of the present disclosure;

FIG. 2 is a diagram for explaining feature amounts of abnormal objects;

FIG. 3 is a graph for explaining a normality determination region and a defect feature region in a coordinate system of basic feature amounts for each abnormality type;

FIG. 4 is a graph for explaining a movement of a coordinate position indicated by measurement values of the basic feature amounts in the coordinate system of the basic feature amounts; and

FIG. 5 is a flowchart for explaining an operation of the image processing apparatus illustrated in FIG. 1.

### DETAILED DESCRIPTION

An embodiment of the present disclosure will be described below with reference to the drawings.

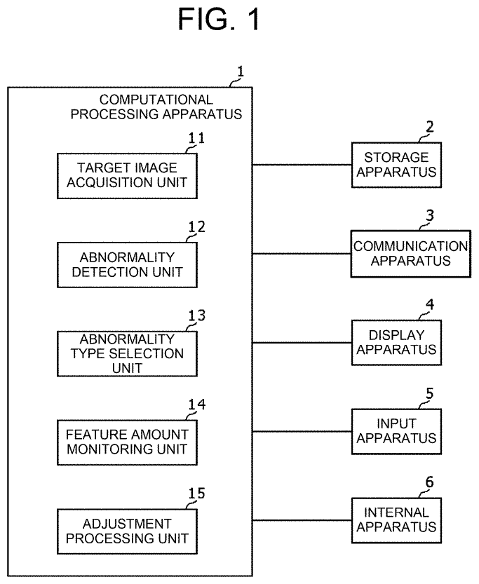

FIG. 1 is a block diagram illustrating a configuration of an image processing apparatus according to an embodiment of the present disclosure. The image processing apparatus illustrated in FIG. 1 is an information processing apparatus such as a personal computer and a server, or an electronic device such as a digital camera and an image forming apparatus (such as a scanner and a multifunction device), and includes a computational processing apparatus 1, a storage apparatus 2, a communication apparatus 3, a display apparatus 4, an input apparatus 5, an internal apparatus 6, and the like.

The computational processing apparatus 1 includes a computer, and executes an image processing program on the computer to operate as various types of processing operators. Specifically, the computer includes a Central Processing Unit (CPU), a Read Only Memory (ROM), a Random Access Memory (RAM), and the like, and loads a program stored in the ROM or the storage apparatus 2 into the RAM and executes the program by the CPU to operate as a specific processing operator. The computational processing apparatus 1 may include an Application Specific Integrated Circuit (ASIC) that functions as a certain processing operator.

The storage apparatus 2 is a non-volatile storage apparatus such as a flash memory, and stores an image processing program and data necessary for a process described later. For example, the image processing program is stored in a non-transitory computer-readable recording medium, and is transferred from the recording medium to be installed in the storage apparatus 2.

The communication apparatus 3 is an apparatus that communicates data with an external apparatus, and is, for example, a network interface, a peripheral device interface, and the like. The display apparatus 4 is an apparatus that displays various types of information to a user, and is, for example, a display panel such as a liquid crystal display. The input apparatus 5 is an apparatus that detects a user operation, and is, for example, a keyboard, a touch panel, and the like.

The internal apparatus 6 is an apparatus that executes a specific function of the image processing apparatus. For example, if the image processing apparatus is an image forming apparatus, the internal apparatus 6 is an image reading apparatus that optically reads a document image from a document, a printing apparatus that prints an image on a printing sheet, and the like.

Here, the computational processing apparatus 1 operates as a target image acquisition unit 11, an abnormality detection unit 12, an abnormality type selection unit 13, a feature amount monitoring unit 14, and an adjustment processing unit 15, which are the above-mentioned processing operators.

The target image acquisition unit 11 repeatedly acquires target images (image data) from the storage apparatus 2, the communication apparatus 3, the internal apparatus 6, and the like, and stores the acquired target images in the RAM or the like. For example, the target images are obtained by scanning a printed material obtained by printing a specific reference image. The reference image (image data) is stored in the storage apparatus 2 in advance.

The abnormality detection unit 12 compares the repeatedly acquired target images with the reference image to detect an abnormal object in the target images.

For example, the abnormality detection unit 12 generates a first feature map obtained by performing a filtering process on the target images and a second feature map obtained by performing the same filtering process on the reference image, generates a difference image between the first feature map and the second feature map, and detects an object in the difference image as an abnormal object. Such a filtering process is set according to the type (dot, streak, and the like) of the abnormal object such as a streak, a dot, and unevenness. For example, a second-order differential filter, a Gabor filter, and the like is used in the filtering process.

The abnormality type selection unit 13 selects, for each of the target images, an abnormality type of the abnormal object from a plurality of specific abnormality types based on values of at least two basic feature amounts. That is, the abnormality type selection unit 13 estimates the abnormality type corresponding to the abnormal object. Specifically, the abnormality type selection unit 13 selects the abnormality type corresponding to the abnormal object, based on a positional relationship between the values of the basic feature amounts and defect feature regions corresponding to the plurality of abnormality types mentioned above, and the like.

At that time, the abnormality type selection unit 13 changes the abnormality type to be selected, in accordance with the change in the values of the basic feature amounts mentioned above.

In the present embodiment, if the values of the basic feature amounts fall within any one of the defect feature regions, the abnormality type selection unit 13 selects an abnormality type of the defect feature region within which the values of the basic feature amounts fall. That is, if the values of the basic feature amounts change over time and the defect feature region within which the values of the basic feature amounts fall changes to another defect feature region, the abnormality type to be selected changes to another abnormality type.

In the present embodiment, if the values of the basic feature amounts do not fall within any of the defect feature regions, the abnormality type selection unit 13 selects the abnormality type, based on a distance from a coordinate position indicated by the values of the basic feature amounts to the defect feature region in a coordinate system of the above-described at least two basic feature amounts. Specifically, an abnormality type for which the above-described distance is shortest is selected. That is, if the values of the basic feature amounts change over time and the defect feature region for which the distance from the coordinate position of the basic feature amounts is shortest changes to another defect feature region, the abnormality type to be selected changes to another abnormality type.

In the present embodiment, if the values of the basic feature amounts do not fall within any of the defect feature regions, the abnormality type selection unit 13 selects the abnormality type, based on a distance from the coordinates indicated by the values of the basic feature amounts to the defect feature region in the coordinate system of the above-described at least two basic feature amounts, and then, if the image quality based on an auxiliary feature amount is not improved after execution of an adjustment process described later, the abnormality type selection unit 13 classifies the abnormal object as an unknown abnormality. That is, if the change in the value of the auxiliary feature amount does not indicate an improvement of the image quality, the abnormal object is classified as an unknown abnormality.

For example, as described later, when known (registered) abnormality types are a drum leak, tailing, and patterns, and if an abnormal object is generated due to dust adhesion, the abnormal object may be classified as an unknown abnormality.

The feature amount monitoring unit 14 monitors the above-mentioned values of the basic feature amounts and a value of one or a plurality of auxiliary feature amounts corresponding to the abnormality type currently selected by the abnormality type selection unit 13.

To monitor the values of the basic feature amounts (or the basic feature amounts and the auxiliary feature amount), the target image acquisition unit 11 repeatedly acquires a target image at a certain time interval or measurement timing, the abnormality detection unit 12 detects an abnormal object from the target image at each acquisition time, and the feature amount monitoring unit 14 identifies values of the basic feature amounts (or the basic feature amounts and the auxiliary feature amount) of the detected abnormal object.

Here, the basic feature amounts and the auxiliary feature amount are selected in advance for each abnormality type from a specific feature amount group, the basic feature amounts are always monitored, and the auxiliary feature amount is only monitored when the basic feature amounts satisfy a certain condition.

For example, the specific feature amount group includes, as feature amounts, an area, orientation, and extension direction of an abnormal object, a density of the abnormal object, an edge intensity (edge density difference) of the abnormal object, a color of the abnormal object, a period of the abnormal object, the number of abnormal objects, and the like.

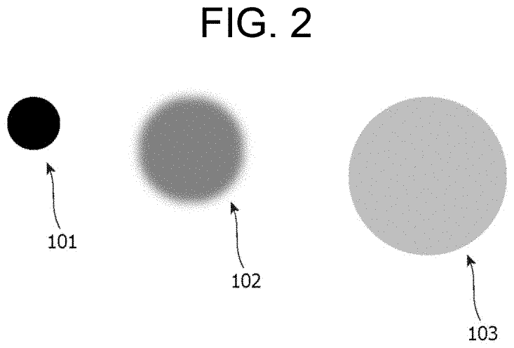

FIG. 2 is a diagram for explaining feature amounts of abnormal objects. For example, abnormal objects 101, 102, and 103 in FIG. 2 have different areas, densities, and edge intensities.

Here, the orientation of an abnormal object is an orientation of the abnormal object in a longitudinal direction. The extension direction is an extension direction of the abnormal object identified from a shape of the abnormal object obtained in a certain time interval. The density of the abnormal object is an average value or a median value of a density of an abnormal object portion in the target image, or a difference value between an average value or a median value of a density of a portion other than the abnormal object in the target image and the average value or the median value of the density of the abnormal object portion. The edge intensity of the abnormal object is a density gradient (density difference) of the edges of the abnormal object in the target image. The color of the abnormal object is a color of the abnormal object in the target image. The period of the abnormal object is a spatial period of a plurality of abnormal objects. The number of abnormal objects is the number of abnormal objects of each object type.

The adjustment processing unit 15 automatically executes an adjustment process (for example, print process conditions) corresponding to the auxiliary feature amount (or the basic feature amounts and the auxiliary feature amount) monitored by the feature amount monitoring unit 14.

The adjustment processing unit 15 executes an adjustment process in the internal apparatus 6 that generates the target image. Specifically, in the adjustment process, a set value of the internal apparatus 6 and set values of various types of processes (such as a printing process) in the internal apparatus 6 are changed. Here, the set values of conditions of an electrophotographic printing process in the printing apparatus as the internal apparatus 6 are adjusted. That is, the adjustment processing unit 15 performs feedback control of the set values of the conditions of the printing process.

If the abnormality type selected by the abnormality type selection unit 13 is changed, the adjustment processing unit 15 executes an adjustment process after the change (here, a setting value of a setting item corresponding to the abnormality type after the change, among the conditions of the printing process), while applying the adjustment process before the change (here, a setting value of a setting item corresponding to the abnormality type before the change, among the conditions of the printing process) (that is, without returning to the setting value before the adjustment process).

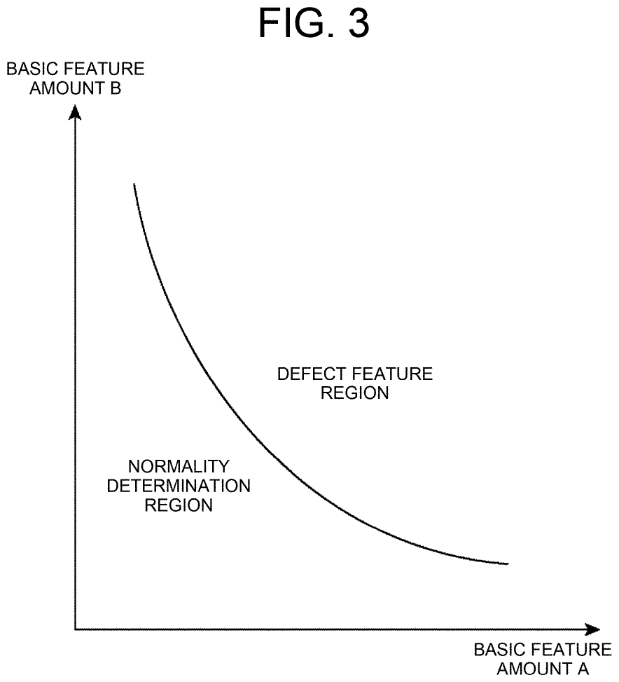

FIG. 3 is a graph for explaining a normality determination region and a defect feature region in a coordinate system of basic feature amounts for each abnormality type. For example, as shown in FIG. 3, in the coordinate system of the basic feature amounts (here, a plane space formed by a basic feature amount A and a basic feature amount B), a normality determination region and a defect feature region exist for each abnormality type. The normality determination region is a region where the adjustment process described later is determined to be unnecessary, and the defect feature region is a region where the adjustment process described later is determined to be necessary.

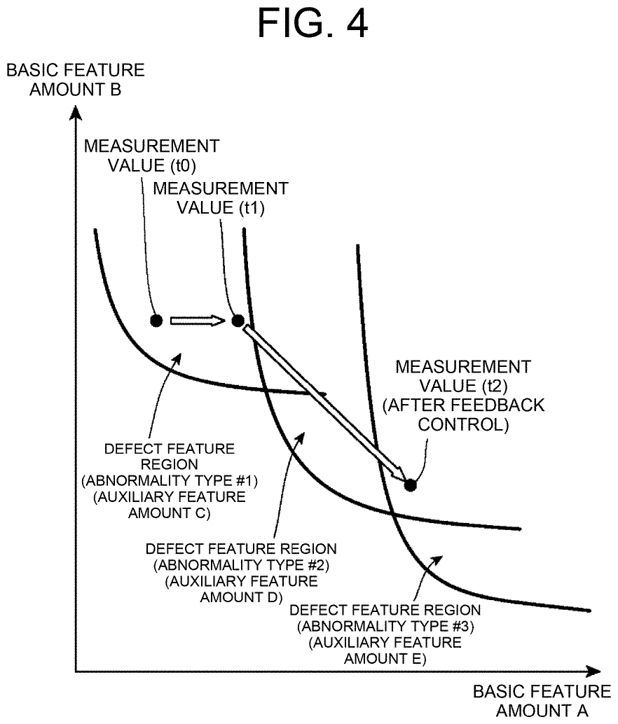

FIG. 4 is a graph for explaining a movement of a coordinate position indicated by measurement values of the basic feature amounts in the coordinate system of the basic feature amounts.

For example, as shown in FIG. 4, for a plurality of abnormality types, a defect feature region is drawn for each abnormality type, and an auxiliary feature amount is attributed to each abnormality type. A list of the plurality of abnormality types, and information about the defect feature region and the auxiliary feature amount associated with each abnormality type are stored in advance in the storage apparatus 2 as data, and are read out to be used as necessary.

In the example shown in FIG. 4, in an initial state (t0), a coordinate position of basic feature amounts of an abnormal object falls within a defect feature region of an abnormality type #1, and monitoring of an auxiliary feature amount C corresponding to the abnormality type #1 is started. After a specific time elapses (at a measurement timing t1), if the abnormal object is detected again and the image quality is not improved and deteriorates due to an increase in area, an adjustment process corresponding to the value of the auxiliary feature amount C is executed. If the abnormality type is correctly selected, the image quality is improved by the adjustment process (that is, the coordinate position of the basic feature amounts moves to the normality determination region).

For example, if the basic feature amount A is the area of the abnormal object, the basic feature amount B is the edge density difference, and the abnormality type #1 is the drum leak, the length of the abnormal object in the lateral direction is set as the auxiliary feature amount C, because the abnormal object caused by the drum leak extends in a lateral direction. The image quality is not improved after a specific time (t1) elapses, and thus, the process conditions are adjusted in accordance with the measurement value of the auxiliary feature amount C, to reduce the drum leak.

However, after the process conditions are adjusted (a measurement timing t2), if the image quality further deteriorates and the coordinate position of the basic feature amounts of the abnormal object deviates from the defect feature region of the abnormality type #1 and falls within a defect feature region of an abnormality type #2 or a defect feature region of an abnormality type #3, the abnormality type to be selected changes from the abnormality type #1 to the abnormality type #2 or the abnormality type #3.

At this time, among the abnormality type #2 and the abnormality type #3, the abnormality type having the shortest distance from the coordinate position of the basic feature amounts to the defect feature region is selected. This distance is the Mahalanobis distance or the Euclidean distance. The maximum likelihood method may be used to select the abnormality type corresponding to the coordinate position of the basic feature amounts.

For example, the abnormality type #2 is the tailing (an image defect caused by overcharging of the toner), and the abnormality type #3 is a pattern. In this case, when the abnormality type #2 is selected, the monitoring of an auxiliary feature amount D is started and the process conditions are adjusted to reduce the tailing, and when the abnormality type #3 is selected, the monitoring of an auxiliary feature amount E is started and the process conditions are adjusted to reduce the pattern. The pattern has a feature in which a white dot changes to a black dot, and thus, color information is used as the auxiliary feature amount E.

After that, if the image quality does not improve, even when the adjustment process is performed, and the coordinate position of the basic feature amounts does not fall within any of the defect feature regions (that is, it is difficult to determine the abnormality type with the basic feature amounts A and B), similarly to the case described above, any one of the abnormality types (for example, the abnormality type having the shortest distance) is selected, for example, based on the distance from the coordinate position of the measurement values of the basic feature amounts to the defect feature region.

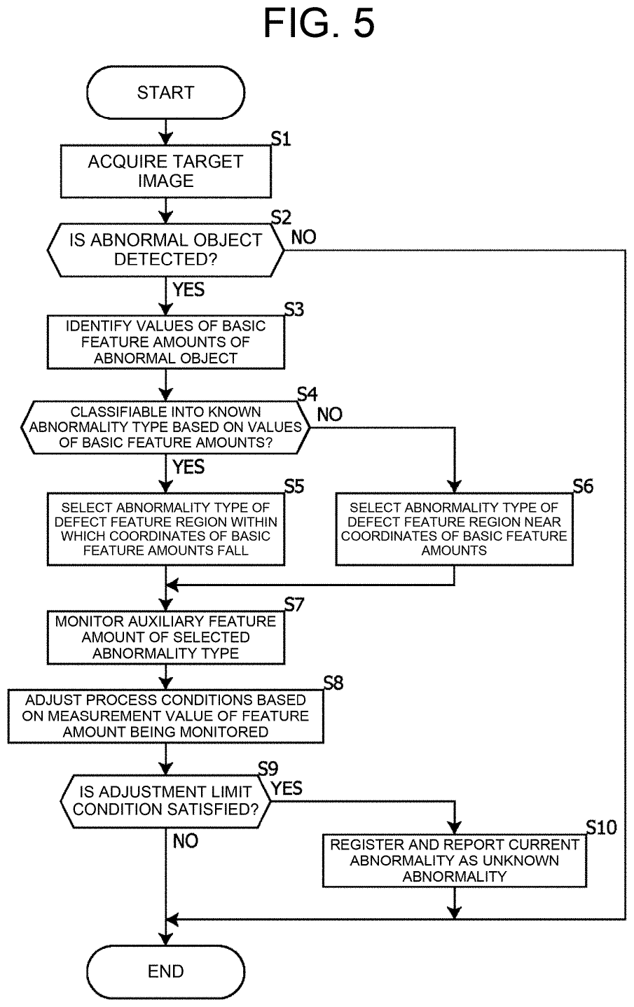

Next, an operation of the image processing apparatus illustrated in FIG. 1 will be described. FIG. 5 is a flowchart for explaining the operation of the image processing apparatus illustrated in FIG. 1.

The target image acquisition unit 11 repeatedly acquires a target image (image data) at a measurement timing (step S1). When the target image is acquired, the abnormality detection unit 12 attempts to detect an abnormal object, based on the target image and a reference image, and determines whether the abnormal object is detected (step S2).

If the abnormal object is not detected, it is determined to be in a normal state and an adjustment process and the like is not executed. On the other hand, if the abnormal object is detected, the feature amount monitoring unit 14 identifies measurement values of the basic feature amounts of the detected abnormal object (a position of coordinates in the coordinate system of the basic feature amounts formed by the values of a plurality of basic feature amounts) (step S3).

Next, the abnormality type selection unit 13 determines whether the abnormal object can be classified into a known abnormality type (step S4). Specifically, the abnormality type selection unit 13 determines whether the coordinate position of the basic feature amounts falls within at least one of a plurality of specific defect feature regions, in the coordinate system of the basic feature amounts.

If the abnormal object can be classified into a known abnormality type, the abnormality type selection unit 13 selects an abnormality type of the defect feature region within which the coordinate position of the basic feature amounts falls (step S5). At this time, if the coordinate position of the basic feature amounts falls within the defect feature regions of a plurality of abnormality types, the abnormality type is selected based on the distance and the like, as described above.

On the other hand, if it is not possible to classify the abnormal object into a known abnormality type, the abnormality type selection unit 13 selects the abnormality type of a defect feature region near the coordinate position of the basic feature amounts (step S6). At this time, as described above, the abnormality type is selected based on the distance or the like.

The feature amount monitoring unit 14 identifies an auxiliary feature amount corresponding to the selected abnormality type, and monitors a value of the auxiliary feature amount (step S7). Specifically, the value of the auxiliary feature amount in the abnormal object is measured. At this time, if the auxiliary feature amount is related to a temporal change (such as an extension of the abnormal object in a certain direction), the value of the auxiliary feature amount is obtained from the next measurement timing after the start of monitoring.

The adjustment processing unit 15 identifies, among the process conditions, an adjustment item corresponding to the abnormality type, and adjusts the set value of the adjustment item according to a measurement value of the auxiliary feature amount or the like (step S8).

Subsequently, if an adjustment limit condition is not satisfied (step S9), the processing at the current measurement timing ends. The adjustment limit condition is a condition that the image quality is not improved after a specific time elapses after the adjustment process, for example. The improvement of the image quality is determined based on the values of the basic feature amounts and the auxiliary feature amount. On the other hand, if the adjustment limit condition is satisfied, the current abnormality (abnormal object) is classified as an unknown abnormality and reported to a user, a service person, or the like (step S10).

After that, if the process conditions are manually adjusted for the unknown abnormality and the image quality improves, a defect feature region, an auxiliary feature amount, and an adjustment process of the unknown abnormality are registered as characteristics of a new abnormality. Thus, from the next timing onward, the adjustment process is automatically performed for the abnormality.

If the abnormality type is correctly selected, the image quality is improved by an appropriate adjustment process and the abnormal object is not detected at the next measurement timing. On the other hand, if the abnormality type is not correctly selected, the image quality is not improved by the adjustment process and the abnormality type is selected again. At that time, if the coordinates of the measurement values of the basic feature amounts move to the defect feature region of another abnormality type, the other abnormality type is selected.

As described above, according to the above-described embodiment, the abnormality detection unit 12 detects an abnormal object in target images that are repeatedly acquired. The abnormality type selection unit 13 selects, for each of the target images, an abnormality type of the abnormal object from a plurality of specific abnormality types based on values of at least two basic feature amounts. The feature amount monitoring unit 14 monitors the values of the basic feature amounts and a value of an auxiliary feature amount corresponding to the abnormality type currently selected by the abnormality type selection unit 13. The adjustment processing unit 15 executes an adjustment process corresponding to the auxiliary feature amount monitored by the feature amount monitoring unit 14. The abnormality type selection unit 13 changes the abnormality type to be selected, in accordance with the change in the values of the basic feature amounts mentioned above.

Therefore, the abnormality type is appropriately selected at each time point, in accordance with the values of the basic feature amounts of the abnormal object that change over time following a progression of the abnormality and the like, an auxiliary feature amount in accordance with the selected abnormality type is selected, and an adjustment process corresponding to the auxiliary feature amount is executed, and thus, it is easy to select an appropriate treatment (adjustment process), and it is easy to improve the image quality when the image quality is abnormal.

It is noted that various changes and modifications to the above-described embodiments will be apparent to those skilled in the art. Such changes and modifications may be made without departing from the gist and scope of the subject matter and without diminishing the intended benefits. That is, it is intended that such changes and modifications are included in the claims.

For example, in the above-described embodiment, if the abnormality type to be selected is changed a specific number of times, it may be determined that the abnormality of the abnormal object is an unknown abnormality, and the process of step S10 described above may be executed.

In the above-described embodiment, if the image quality does not improve even though the adjustment process is applied for a specific time to a certain abnormality type, the abnormality type selection unit 13 may forcibly change the currently selected abnormality type to another abnormality type (an abnormality type selected by the distance and the like, as described above, from abnormality types other than the currently selected abnormality type).

The present disclosure is applicable, for example, to the detection of an abnormality in an image forming apparatus and the like.

What is claimed is:

1. An image processing apparatus comprising:
an abnormality detection unit that detects an abnormal object in target images repeatedly acquired;
an abnormality type selection unit that selects, for each of the target images, an abnormality type of the abnormal object from a plurality of specific abnormality types based on values of at least two basic feature amounts;
a feature amount monitoring unit that monitors the values of the at least two basic feature amounts and a value of an auxiliary feature amount corresponding to the abnormality type currently selected by the abnormality type selection unit; and
an adjustment processing unit that executes an adjustment process corresponding to the auxiliary feature amount being monitored by the feature amount monitoring unit, wherein
the abnormality type selection unit changes the abnormality type to be selected, in accordance with a change in the values of the at least two basic feature amounts.

2. The image processing apparatus according to claim 1, wherein, if the values of the at least two basic feature amounts fall within a defect feature region of a plurality of defect feature regions corresponding to the plurality of specific abnormality types, the abnormality type selection unit selects an abnormality type of the defect feature region within which the values of the at least two basic feature amounts fall.

3. The image processing apparatus according to claim 2, wherein, if the values of the at least two basic feature amounts do not fall within any of the plurality of defect feature regions, the abnormality type selection unit selects an abnormality type, based on a distance from coordinates indicated by the values of the at least two basic feature amounts to the defect feature region in a coordinate system of the least two basic feature amounts.

4. The image processing apparatus according to claim 3, wherein, if the values of the at least two basic feature amounts do not fall within any of the plurality of defect feature regions, the abnormality type selection unit selects an abnormality type, based on a distance from coordinates indicated by the values of the at least two basic feature amounts to the defect feature region in the coordinate system of the at least two basic feature amounts, and subsequently, if an image quality based on the auxiliary feature amount is not improved after execution of the adjustment process, the abnormality type selection unit classifies the abnormal object as an unknown abnormality.

5. The image processing apparatus according to claim 1, wherein, if the abnormality type selected by the abnormality type selection unit is changed, the adjustment processing unit executes an adjustment process after the change, while applying the adjustment process before the change.

6. An image forming apparatus comprising:
the image processing apparatus according to claim 1; and
an internal apparatus that generates the target images.

7. An image processing method comprising:
detecting an abnormal object in target images repeatedly acquired;
selecting, for each of the target images, an abnormality type of the abnormal object from a plurality of specific abnormality types based on values of at least two basic feature amounts;
monitoring the values of the at least two basic feature amounts and a value of an auxiliary feature amount corresponding to the abnormality type currently selected in the selecting; and
executing an adjustment process corresponding to the auxiliary feature amount being monitored in the monitoring, wherein
in the selecting, the abnormality type to be selected is changed in accordance with a change in the values of the at least two basic feature amounts.
